(19) United States
(12) Patent Application Publication
(10) Pub. No.: US 2006/0109973 A1
(43) Pub. Date: May 25, 2006

(54) Method for conveying call origination information in a predictive dialing environment

(76) Inventor: Marshall L. Peltz, LaGrange Park, IL (US)

Correspondence Address: Jon P. Christensen;Welsh & Katz, Ltd., 22nd Floor, 120 South Riverside Plaza, Chicago, IL, 60606, US

(21) Appl. No.: 10/992,965

(22) Filed: Nov. 19, 2004

(51) Int. Cl. H04M 3/00; H04M 5/00; H04M 7/00

(52) U.S. Cl. 379/265.02; 379/220.01

(57) ABSTRACT

A method and apparatus are provided for processing a call through the public switched telephone network. The method includes the steps of sending a call request for a switched circuit connection between a telephone call contractor and a called party, the call request being sent from the call contractor to a local switching office of the public switched telephone network in the context where said call contractor has contracted with a third party to call the called party and sending an identifier of the third party along with the call request as a source identifier of the call request, said source identifier of the third party being different than the call contractor and also different than the called party, the call request source identifier being sent along with the connection request instead of an identifier of the call contractor that requested the connection.

### FIELD OF THE INVENTION

The field of the invention relates to communication systems and more particularly to automatic call distributors.

### BACKGROUND OF THE INVENTION

Automatic call distributors (ACDs) are known. Such systems are typically used by organizations to serve large numbers of callers through the Public Switched Telephone Network (PSTN). Typically, inbound calls are directed to a common telephone number of the organization and distributed to agents based upon some criteria (e.g., agent idle time).

In addition to handling inbound calls, ACDs may also process outbound calls. Typically, a controller monitors a workload of its agents. Where a workload of received calls falls below some threshold value, the controller may begin to initiate outbound calls.

In addition to placing and distributing calls, an ACD may also identify and display documents on agent terminals as an aid to processing the calls. In the case of incoming calls, the calls may be received along with dialed number identification service (DNIS) and/or automatic number identification (ANI) information. ANI may be used to identify a caller at the same instant as the call is delivered to the ACD. The controller of the ACD may use the ANI information to retrieve and display customer records on a terminal of the agent selected to handle the call at the same instant that the call is delivered to the agent.

In addition, textual information may be displayed on a terminal of the agent that guides the agent through a sales presentation. DNIS information may be used to identify an intended call target and to select an appropriate sales presentation for use by the agent based upon the intended call target.

While automatic call distributors work relatively well, they are not particularly well suited to an environment where caller ID is available and that functions to identify calls from telemarketers. In the case where a called party is able to identify the call as being from a telemarketer, the called party is often hesitant to answer the call. The hesitancy to answer the call defeats the purpose of the call. Because of the importance of telemarketing, a need exists for a more flexible method of presenting call origination information.

### SUMMARY

A method and apparatus are provided for processing a call through the public switched telephone network. The method includes the steps of sending a call request for a switched circuit connection between a telephone call contractor and a called party, the call request being sent from the call contractor to a local switching office of the public switched telephone network in the context where said call contractor has contracted with a third party to call the called party. The method also includes the step of sending an identifier of the third party along with the call request as a source identifier of the call request, said source identifier of the third party being different than the call contractor and also different than the called party, the call request source identifier being sent along with the connection request instead of an identifier of the call contractor that requested the connection.

### BRIEF DESCRIPTION OF THE DRAWINGS

FIG. 1 is a block diagram of a system used by a call contractor in accordance with an illustrated embodiment of the invention.

### DETAILED DESCRIPTION OF AN ILLUSTRATED EMBODIMENT

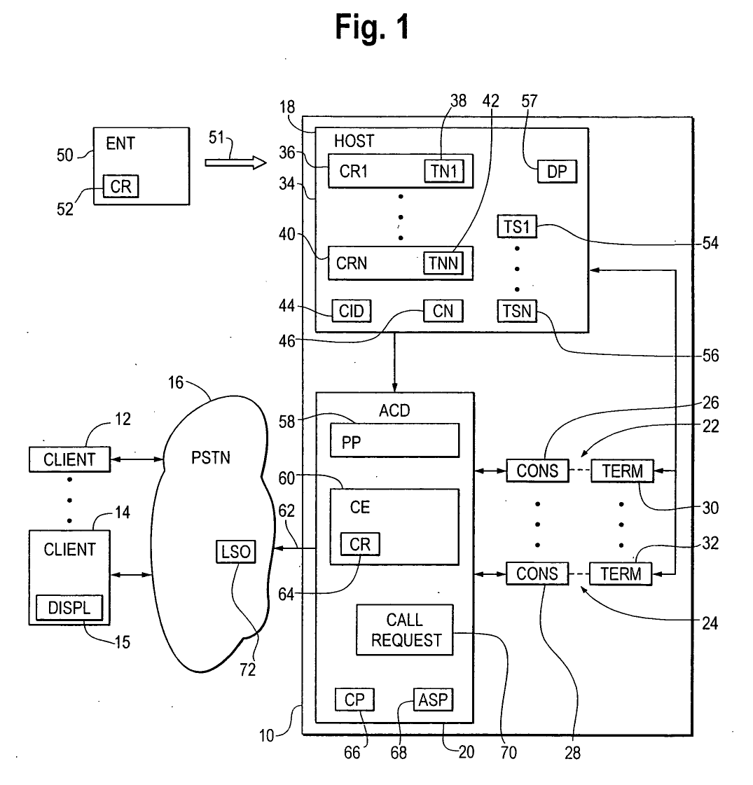

FIG. 1 is a block diagram of contractor system (e.g., an automatic call distributor (ACD)) 10 used by a call contractor under an illustrated embodiment of the invention. The contractor (ACD) system 10 may be used by a telephone call contractor to deliver calls to (and receive calls from) subscribers of the PSTN on behalf of some other enterprise. As used herein, the term “telephone call contractor” or “call contractor” means an entity (e.g., a company, corporation, etc.) that contracts with one or more other organizations (third parties) to deliver information through the PSTN to a called party (i.e., a telephone subscriber) identified by the third party and which calling entity (i.e., the call contractor) is not related to the called party or the third party. Not related means that there is no employer/employee relationship among the calling entity, the called entity and the third party and that the calling entity, the called entity and the third party all have separate source identifiers (i.e., telephone numbers) within the PSTN.

In addition to delivering information to the subscriber, the telephone contractor may also be authorized to engage in transactions (e.g., receive orders or donations from, make agreements with, etc.) the called party on behalf of the third party.

For sake of clarity in this description, the organization that contracts to have the call made (but which does not make the actual call) will be referred to as the “call originator”. In contrast, the call contractor will be referred to as the caller or the call requester.

The call contractor may process calls in a manner similar to telemarketers with one important exception. The exception is that the call contractor does not process calls for the benefit of the call contractor (except for any commission received for executing the call), but instead processes the call for the direct financial benefit of the third party who requests that the calls be made.

In general, the call contractor may be used by any of a number of different enterprise organizations (e.g., commercial, environmental, political, etc.) to advance the agenda of the enterprise. For example, a merchant may have a new product line and may wish to call a number of existing customers to alert those customers to the new product line. However, the merchant may not have telemarketers or the ability to perform telemarketing.

To meet this need, the call contractor may enter into a contract with the merchant to perform the merchant's telemarketing. To advance this process, the merchant may provide the call contractor with a list of telephone numbers (a call list) and text that describes products to be marketed.

More sophisticated enterprises may provide customer files along with telephone numbers. Prepared text may be provided and recited by agents of the call contractor to the enterprise's customers as part of the telemarketing effort.

On the other hand, for purposes of customer perception or customer loyalty, the organization may wish the keep the contractor's presence in the transaction confidential. In order to maintain the confidentiality of the contractor's presence, the call to the customer may be accompanied by the call identifier (ID) and name of the merchant rather than the call ID and name of the contractor. As is well known in the art, telephone systems typically deliver the ID of the caller rather than the ID of some other party. In this regard, the system described below differs in significant degree from other, prior art systems.

Turning now to the system 10, an explanation will be provided as to operation of the system 10. In this regard, the system 10 may include a host 18, a call distributor 20 and one or more agent stations 22, 24. Calls from the contractor system 10 may be placed to one or more of the clients 12, 14 of the enterprise 50 through the PSTN 16.

In order for the contractor 10 to initiate a call campaign for the enterprise 50, the enterprise 50 may transfer a campaign file 34, 52 to the host 18. Contained within the campaign file 34 may be one or more client records 36, 40. Included within the client records 36, 40 may be a customer history (e.g., previous purchases, buying habits, backordered items, etc.) and a telephone number 38, 42 of the client 12, 14. Also included within the campaign file may be text scripts 54, 56 and a set of identifiers 44, 46 of the organization. The first identifier 44 may be a call identifier (e.g., telephone number of the organization 50). The second identifier 46 may be an alphanumeric string (e.g., ASCII characters) that provides a name of the organization.

Once the campaign files have been received by the host 18, a make call (pacing) processor 58 within the call distributor 20 may begin placing calls. In this regard, calls may be placed based upon the availability of agents 22, 24. As each new agent 22, 24 becomes available, the pacing processor 58 may retrieve a new telephone number 38, 42 from the campaign file 34 and place a call.

The call connection 62 between the contractor system 10 and PSTN 16 may be provided under an ISDN format. The connection 62 may be provided with any appropriate capacity (e.g., BRI, PRI, T1, etc.).

In order to make a call, the pacing processor 58 may transfer (or instruct the host 18) to transfer a make call information packet to the make call encoder 60. The make call packet may include at least a telephone number of the client 12, 14 and the telephone number 44 and name 46 of the organization 50 that requested the call to the call encoder 60.

The call encoder 60 may encode the make call information packet into a make call message (call request) 70 for transfer to a local switching office (LSO) 72 of the PSTN 16. Where the call connection 62 operates under an ISDN format, the call encoder 60 may select an idle channel of the connection 62 and transfer the make call message over a “D” channel to the LSO.

The encoder 50 may also open a pending call record 64. Within the call record 64, the telephone number of the client 12, 14, the name and number of the organization 50 and an identifier of the selected channel may be saved.

As specified by the International Telecommunication Union, Telecommunications Standardization Sector (ITU-T) and other international standards, a make call message may be transferred to the PSTN on the D channel within a repeating frame structure containing information within a number of necessary and optional fields. The call encoder 60 may encode the telephone number of the client 12, 14 into a necessary first field (i.e., a called number field). Under ITU-T specification Q951 and Q931, the telephone number 44 of the organization 50 may be encoded into a second optional field (i.e., a calling party number information field) and the name of the organization 50 may be encoded under an IA5 format into a third optional field (i.e., a calling party sub-address information element field).

The encoding of the telephone number and name of the organization into the second and third fields causes the telephone number and name of the organization 50 to appear in a Calling Line Identification Presentation (CLIP) on a display (e.g., 15) of the client's telephone 12, 14 at the instant of call delivery. This display of the organization's information on the display 15 is in direct contravention of conventional practice where the caller's telephone number should normally appear on the display 15.

The display of the name and telephone number of telemarketers has been found to result in many incomplete calls. This problem has not been generally recognized within the industry. Contravention of the original intent of the ITU-T in this example (by display of the organization's information rather than the contractor's information) is justified by the fact that the contractor 10 is acting as an authorized agent of the organization.

The display of the organization's name and number on the display 15 has the positive effect of allowing the client 12, 14 to react in accordance with their view of the organization 50 rather than their view of the contractor 10. It also has the positive effect of allowing the contractor 10 to serve many different organizations 50 with the client 12, 14 reacting to the arrival of the call in conformance with their view of the different organizations that originated the call.

Continuing with the example, once the call arrives at the telephone of the client 12, 14, the call may be processed as follows. When the client 12, 14 answers the call, a call processor 66 may retrieve the call record 64 using an identifier of the selected channel and transfer the call record 64 to an agent selection processor 68.

From the call record 64, the agent selection processor 68 may determine a subject matter of the call and select an agent 22, 24 based upon the skill of the agent and the subject matter of the call. The call selection processor 68 may then transfer the call to a console 26, 28 of the select agent 22, 24. At the same time the agent selection processor may transfer the call record 64 and an identifier of the selected agent to a display processor 57 within the host 18.

Within the display processor 57, the call record may be used to identify a text file 54, 56 associated with the call. The text file 54, 56 may contain text that is to be followed by agent 22, 24 in his conversation with the client 22, 24.

Once a text file 54, 56, is identified, the display processor 57 may transfer the file 54, 56 to a terminal 30, 32 of the selected agent 22, 24. The text may be displayed on a terminal 30, 32 of the selected agent 22, 24 at the same instant as call delivery. The display of the text associated with the call allows the selected agent 22, 24 to converse with the client 12, 14 in a manner that leads the client 12, 14 to believe that they are conversing with an employee of the enterprise 50.

The text files 54, 56 may also contain a number of interactive windows. If the enterprise 50 is a merchant, the interactive window allows the agent 22, 24 to enter order information, receive donations or enter into agreements according to the objective of the organization 50. Any information collected by the agent 22, 24 may be transferred back to the organization 50 through a data link 51 or otherwise.

In another embodiment, the contractor 10 may also do direct telemarketing of its own products. In this case, the second and third fields may be used conventionally where an identifier of the agent 22, 24 may be inserted for display on the display 15 of the client 12, 14. Alternatively, where the second and third fields are left blank, the default standards of the ITU-T will automatically insert an identifier and name of the contractor 10.

A specific embodiment of method and apparatus for displaying call origination information has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of processing a call through the public switched telephone network, said method comprising:
sending a call request for a switched circuit connection between a telephone call contractor and a called party, said call request being sent from the call contractor to a local switching office of the public switched telephone network in the context where said call contractor has contracted with a third party to call the called party; and
sending an identifier of the third party along with the call request as a source identifier of the call request, said source identifier of the third party being different than the call contractor and also different than the called party, the call request source identifier being sent along with the connection request instead of an identifier of the call contractor that requested the connection.

2. The method of processing the call as in claim 1 further comprising displaying the identifier of the third party on a telephone of the called party.

3. The method of processing the call as in claim 2 further comprising sending a telephone number of the third party along with the connection request from the call contractor to the public switched telephone network.

4. The method of processing the call as in claim 3 further comprising displaying the telephone number of the third party on the telephone of the called party when the call is delivered to the called party.

5. The method of processing the call as in claim 4 further comprising detecting the called party answering the call.

6. The method of processing the call as in claim 5 further comprising assigning the answered call to an agent of the call contractor.

7. The method of processing the call as in claim 6 further comprising presenting information supplied by the third party by the assigned agent to the called party.

8. The method of processing the call as in claim 7 wherein the step of presenting the information supplied by the third party further comprises displaying script on a terminal of the agent that the agent reads to the called party.

9. The method of processing the call as in claim 1 further comprising the third party providing the call contractor with a list of telephone numbers for the call contractor to call on behalf of the third party.

10. The method of processing the call as in claim 1 further comprising the call contractor collecting information from the called party and forwarding the collected information to the third party.

11. An apparatus for processing a call through the public switched telephone network, said apparatus comprising:
means for sending a call request for a switched circuit connection between a telephone call contractor and a called party, said call request being sent from the call contractor to a local switching office of the public switched telephone network in the context where said call contractor has contracted with a third party to call the called party; and
means for sending an identifier of the third party along with the call request as a source identifier of the call request, said source identifier of the third party being different than the call contractor and also different than the called party, the call request source identifier being sent along with the connection request instead of an identifier of the call contractor that requested the connection.

12. The apparatus for processing the call as in claim 11 further comprising means for displaying the identifier of the third party on a telephone of the called party.

13. The apparatus for processing the call as in claim 12 further comprising means for sending a telephone number of the third party along with the connection request from the call contractor to the public switched telephone network.

14. The apparatus for processing the call as in claim 13 further comprising means for displaying the telephone number of the third party on the telephone of the called party when the call is delivered to the called party.

15. The apparatus for processing the call as in claim 14 further comprising means for detecting the called party answering the call.

16. The apparatus for processing the call as in claim 15 further comprising means for assigning the answered call to an agent of the call contractor.

17. The apparatus for processing the call as in claim 16 further comprising means for presenting information supplied by the third party by the assigned agent to the called party.

18. The apparatus for processing the call as in claim 17 wherein the means for presenting the information supplied by the third party further comprises means for displaying script on a terminal of the agent that the agent reads to the called party.

19. The apparatus for processing the call as in claim 11 further comprising means for allowing the third party to provide the call contractor with a list of telephone numbers for the call contractor to call on behalf of the third party.

20. The apparatus for processing the call as in claim 11 further comprising means for allowing the call contractor to collect information from the called party and forwarding the collected information to the third party.

21. An apparatus for processing a call through the public switched telephone network, said apparatus comprising:
a call request for a switched circuit connection that is sent between a telephone call contractor and a called party, said call request being sent from the call contractor to a local switching office of the public switched telephone network in the context where said call contractor has contracted with a third party to call the called party; and
an identifier of the third party that is sent along with the call request as a source identifier of the call request, said source identifier of the third party being different than the call contractor and also different than the called party, the call request source identifier being sent along with the connection request instead of an identifier of the call contractor that requested the connection.

22. The apparatus for processing the call as in claim 21 further comprising an encoder adapted to send a telephone number of the third party along with the connection request from the call contractor to the public switched telephone network.

23. The apparatus for processing the call as in claim 21 further comprising a call processor adapted to detect the called party answering the call.

24. The apparatus for processing the call as in claim 23 further comprising an agent assignment processor adapted to assign the answered call to an agent of the call contractor.

25. The apparatus for processing the call as in claim 24 further comprising text information supplied by the third party for presentation by the assigned agent to the called party during the call.

26. The apparatus for processing the call as in claim 21 further comprising a list of telephone numbers provided by the third party for the call contractor to call on behalf of the third party.

27. A method of processing a call through the public switched telephone network, said method comprising:
sending a connection request from a first party telephone call contractor to the public switched telephone network; and
sending an identifier of a third party that is different than the first party along with the connection request instead of an identifier of the first party that requested the connection.
